(19) United States
(12) Patent Application Publication
(10) Pub. No.: US 2014/0154934 A1
(43) Pub. Date: Jun. 5, 2014

(54) AMPHIBIOUS OR MARINE APPARATUS, AND METHODS OF MAKING AND USING SAME

(71) Applicant: Robert C. Brown, Yale, MI (US)

(72) Inventor: Robert C. Brown, Yale, MI (US)

(21) Appl. No.: 13/692,964

(22) Filed: Dec. 3, 2012

(51) Int. Cl. B60F 3/00; B63H 21/17

(52) U.S. Cl. CPC B60F 3/0038; B63H 21/17
USPC 440/6

(57) ABSTRACT

Apparatus to convert an all terrain vehicle into an amphibious off-road vehicle. The apparatus can thus be used with an all terrain vehicle, or alternatively with a snap in seat to form a self-contained independent boat. The apparatus is fitted to the all terrain vehicle with releasable fasteners. The apparatus includes two floatation compartments, and a hollow floatation compartment that accommodate the legs and feet of a user.

The present invention relates generally to an amphibious or marine apparatus, and methods of making and using same.

More particularly, the present invention relates to an apparatus to convert an all terrain vehicle into an amphibious off-road vehicle, or alternatively with a snap in seat to be used as a self-contained marine vehicle without an all terrain vehicle, and methods of constructing and utilizing same.

### BACKGROUND OF THE INVENTION

The present invention avoids the animadversions of the existing devices and techniques, and provides an independent boat or an apparatus to convert an all terrain vehicle to an amphibious off-road vehicle.

### SUMMARY OF THE INVENTION

The present invention provides an apparatus to convert an all terrain vehicle into an amphibious off-road vehicle, comprising, in combination: an all terrain vehicle; a buoyant unitary structure for fitting over and onto said all terrain vehicle; fastening means for releasably securing said buoyant unitary structure to said all terrain vehicle; said buoyant unitary structure including two hollow floatation compartments to accommodate legs and feet of a user of said apparatus; said buoyant unitary structure includes in a front portion thereof a first watertight floatation compartment having therein an electrical battery and space for accommodating other items to be stored therein; said buoyant unitary structure includes in a rear portion thereof a second watertight floatation compartment having built therein an inboard electric motor and space for accommodating other items to be stored therein; marine propulsion means operatively connected with said buoyant unitary structure; said marine propulsion means includes said inboard electric motor built into said buoyant unitary structure, and a propeller operatively mounted to a rear portion of said buoyant unitary structure; said inboard electric motor deriving its power from said electrical battery; a rudder operatively mounted to a rear portion of said buoyant unitary structure; a joystick throttle control mechanism operatively mounted on said buoyant unitary structure; said joystick throttle control mechanism controls said rudder and controls said inboard electric motor to provide variable speed, forward and reverse motion; and means for charging said electrical battery from an engine in said all terrain vehicle when said engine is operated.

The present invention also provides a marine vehicle comprising, in combination: a buoyant unitary structure having an opening in an upper central portion thereof; a seat device for selectively and releasably snapping into said opening to complete said upper portion of said buoyant unitary structure and to form a watertight structure; said buoyant unitary structure including two hollow floatation compartments to accommodate legs and feet of a user of the marine vehicle; said buoyant unitary structure includes in a front portion thereof a first watertight floatation compartment having therein an electrical battery and space for accommodating other items to be stored therein; said buoyant unitary structure includes in a rear portion thereof a second watertight floatation compartment having built therein an inboard electric motor and space for accommodating other items to be stored therein; marine propulsion means operatively built into buoyant unitary structure; said marine propulsion means includes said inboard electric motor built into said buoyant unitary structure, and a propeller operatively mounted to a rear portion of said buoyant unitary said inboard electric motor deriving its power from said electrical battery; a rudder operatively mounted to a rear portion of said buoyant unitary structure; a joystick throttle control mechanism operatively mounted on said buoyant unitary structure; and said joystick throttle control mechanism controls said rudder and controls said inboard electric motor to provide variable speed, forward and reverse motion.

The present invention also provides a buoyant unitary apparatus, comprising: a buoyant unitary structure having an opening in an upper central portion thereof; said buoyant unitary structure being designed, dimensioned and configured to selectively and releasably fit over and onto an external all terrain vehicle; said buoyant unitary structure including two hollow floatation compartments which accommodate legs and feet of a user; said buoyant unitary structure includes in a front portion thereof a first watertight floatation compartment having therein an electrical battery and space for accommodating other items to be stored therein; said first buoyant unitary structure includes in a rear portion thereof a second watertight floatation compartment having built therein an inboard electric motor and space for accommodating other items to be stored therein; marine propulsion means operatively connected with said buoyant unitary structure; said marine propulsion means includes said inboard electric motor built into said buoyant unitary structure, and a propeller operatively mounted to a rear portion of said buoyant unitary structure; said inboard electric motor deriving its power from said electrical battery; a rudder operatively mounted to a rear portion of said buoyant unitary structure; a joystick throttle control mechanism operatively mounted on said buoyant unitary structure; and said joystick throttle control mechanism controls said rudder and controls said inboard electric motor to provide variable speed, forward and reverse motion.

An object of the invention is to apparatus to convert an all terrain vehicle into an amphibious off-road vehicle, or alternatively with a snap in seat to provide an independent boat.

Another object of the invention is to provide an apparatus, as described herein, to convert an all terrain vehicle into an amphibious off-road vehicle suitable for lakes and rivers.

Another object of the present invention is to provide such a novel and unique apparatus, as described herein, which includes a molded high impact polyethylene body with buoyant air pockets built in the front and back portions thereof.

Yet a further object of the present invention is to provide such a novel and unique apparatus, as described herein, which fits over an existing all terrain vehicle and attaches with four bolts enabling any all terrain vehicle to be converted to a small boat in less than five minutes.

Another object of the present invention is to provide such a novel and unique apparatus, as described herein, which comprises a sleek, lightweight, one-piece shell with an inboard electric motor.

Yet a further object of the present invention is to provide such a novel and unique apparatus, described herein, which includes optional storage racks at the front and rear portions thereof.

Yet a further object of the present invention is to provide such a novel and unique apparatus, described herein, which includes two hollow floatation compartment which accommodate the legs and feet of the user of the vehicle.

Another object of the present invention is to provide such a novel and unique apparatus, described herein, which includes a recessed structure to protect the propeller.

A further object of the present invention is to provide such a novel and unique apparatus, as described herein, which includes marine propulsion means to help propel said apparatus through a body of water.

Further objects, advantages, and features of the present invention will become more apparent to those persons skilled in this particular area of technology and to other persons after having been exposed to the detailed description as forth hereinbelow in conjunction with the accompanying patent drawings.

### BRIEF DESCRIPTION OF THE DRAWINGS

FIG. 1 illustrates a first embodiment of the present invention just prior to conversion of an all terrain vehicle into an amphibious off-road vehicle.

FIG. 2 shows a side elevational view of the FIG. 1 components after conversion to an amphibious off-road vehicle.

FIG. 3 illustrates a top plan view of the assembled components as depicted in FIG. 2.

FIG. 4 a second embodiment of the present invention just prior to assembly.

FIG. 5 shows a side elevational view of the assembled FIG. 4 components.

FIG. 6 shows a top plan view of the assembled components as depicted in FIG. 5.

FIG. 7 illustrates the FIG. 2 vehicle showing additional internal parts.

FIG. 8 illustrates the FIG. 5 vehicle with some internal parts omitted for clarity.

### DETAILED DESCRIPTION OF SOME PREFERRED EMBODIMENTS OF THE PRESENT INVENTION

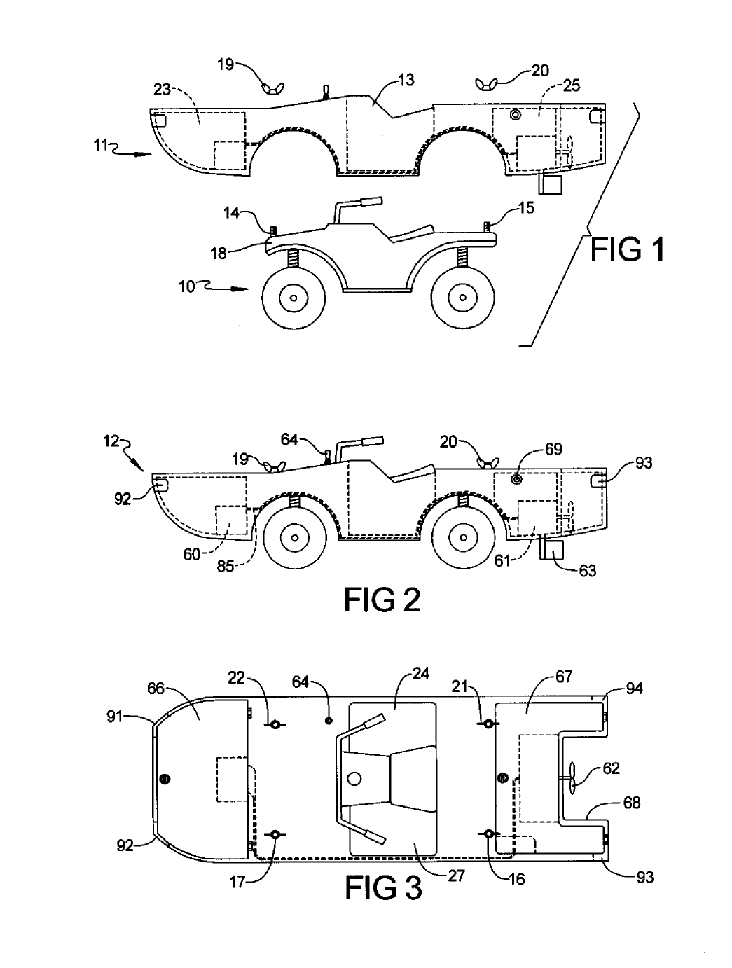

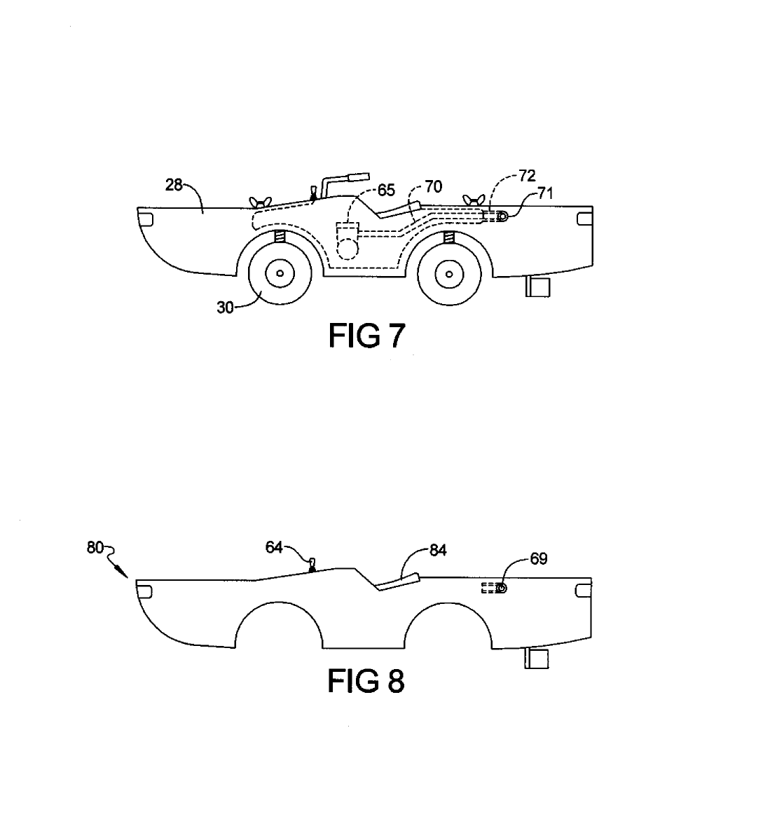

FIGS. 1-3 and 7 illustrate an apparatus 11 to convert an all terrain vehicle 10 into an amphibious off-road vehicle 12, comprising, in combination: an all terrain vehicle 10; a buoyant unitary structure 13 for fitting over and onto said all terrain vehicle 10; fastening means 14-17 and 19-22 for releasably securing said buoyant unitary structure 13 to said all terrain vehicle 10; said buoyant unitary structure 13 including two hollow floatation compartments 24 and 27 which accommodate legs and feet of a user of said apparatus 11; said buoyant unitary structure 13 includes in a front portion thereof a first watertight floatation compartment 23 having therein an electrical battery 60 and space for accommodating other items to be stored therein; said buoyant unitary structure 13 includes in a rear portion thereof a second watertight floatation compartment 25 having built therein an inboard electric motor 61 and space for accommodating other items to be stored therein; marine propulsion means operatively connected with said buoyant unitary structure 13; said marine propulsion means deriving its power from said electrical battery 60; said marine propulsion means includes said inboard electric motor 61 built into said buoyant unitary structure 13, and a propeller 62 operatively mounted to a rear portion of said buoyant unitary structure 13; said inboard electric motor 61 deriving its power from said electrical battery 60; a rudder 63 operatively mounted to a rear portion of said buoyant unitary structure 13; a joystick throttle control mechanism 64 operatively mounted on said buoyant unitary structure 13; said joystick throttle control mechanism 64 controls said rudder 63 and controls said inboard electric motor 61 to provide variable speed, forward and reverse motion; and means for charging said electrical battery 60 from an engine 65 in said all terrain vehicle 10 when said engine 65 is operated.

With reference to FIG. 1, there is shown the all terrain vehicle 10 and the apparatus 11 for converting the all terrain vehicle 10 into an amphibious off-road vehicle 12, which is shown assembled in FIGS. 2, 3 and 7.

The apparatus 11 includes a buoyant unitary structure 13 for fitting over and onto the all terrain vehicle 10, and predetermined fastening means 14-17 and 19-22 for releasably securing the buoyant unitary structure 13 to the all terrain vehicle 10.

The fastening means includes four upwardly extending bolts 14, 15, 16 and 17 attached to the frame 18 of the all terrain vehicle 10, and wing nuts or knobs 19, 20, 21 and 22 for releasable and threaded engagement with the bolts 14, 15, 16 and 17, respectively.

The buoyant unitary structure 13 includes compartments 24 and 27 to accommodate the legs and feet of a user of the vehicle 12 and to serve as air pockets for floatation and lateral stability.

The buoyant unitary structure 13 comprises a molded high-impact polyethylene body 28 that is formed to fit over and onto the existing all terrain vehicle 10.

The buoyant structure 13 includes in the front portion thereof the first watertight compartment 23 which has an openable watertight lid 66 and which houses the electrical battery 60 and other items to be stored therein.

The buoyant unitary structure 13 includes in the rear portion thereof the second watertight compartment 25 which has an openable watertight lid 67 and which houses the inboard electric motor 61 and other items to be stored therein.

The first watertight floatation compartment 23 extends beyond said all terrain vehicle 10 to increase floatation of the amphibious off-road vehicle 12.

The second watertight floatation compartment 25 extends beyond said all terrain vehicle 10 to increase floatation of the amphibious off-road vehicle 12, and extends rearwardly to provide a recessed structure 68 outboard of the propeller 62 to protect the propeller 62 from damage.

The propeller 62 is positioned in the recessed structure 68 for protection.

A snorkel device 69 is built into an upper portion of the buoyant unitary structure 13, and operatively connects an exhaust pipe 70 of said all terrain vehicle 10 to the atmosphere.

A heat-resistant barrier 71 is built in around the snorkel device 69.

An adaptor coupling 72 forms part of the snorkel device 69 for selectively and releasably clamping the snorkel device 69 onto an end of the exhaust pipe 70 of said all terrain vehicle 10.

The joystick throttle/steering controller mechanism 64 controls speed, forward, reverse, and steering the rudder 63.

An electrical cable 85 electrically interconnects the battery 60 and the motor 61.

There are provided wrap-around lights 91-94 which are powered by battery 60 or the engine 65 when engine 65 is operated.

The inboard electric motor 61 may be used whenever desired, for example, for upstream travel in streams with a heavier current.

With the components 14-17 and 19-22 and structure 13 described hereinabove, the user is able to convert the all terrain vehicle 10 to become essentially a small boat 12 which uses the motor 61 for propulsion, and which propulsion can be augmented by the engine 65 and wheels 30 of the all terrain vehicle 10 when the wheels 30 are in contact with the ground.

A second embodiment of the present invention will now be described hereinbelow wherein reference numbers for components similar to the above-described embodiment are used to designate similar parts of the second embodiment.

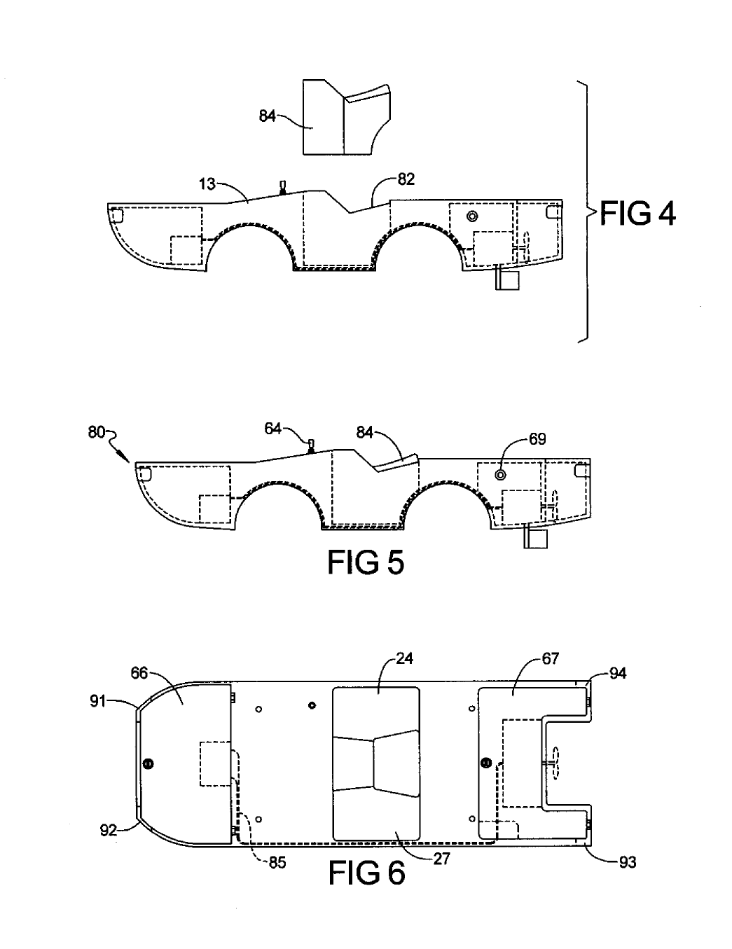

FIGS. 4-6 and 8 illustrate a marine vehicle 80, comprising, in combination: a buoyant unitary structure 13 having an opening 82 in an upper central portion thereof; a seat device 84 for selectively and releasably snapping into and filling said opening 82 to complete said top portion of said buoyant unitary structure 13 and to form a watertight structure; said buoyant unitary structure 13 including two hollow floatation compartments 24 and 27 which accommodate legs and feet of a user of the marine vehicle 80; said buoyant unitary structure 13 includes in a front portion thereof a first watertight floatation compartment 23 having therein an electrical battery 60 and space for accommodating other items to be stored therein; said buoyant unitary structure 13 includes in a rear portion thereof a second watertight floatation compartment 25 having built therein an inboard electric motor 61 and space for accommodating other items to be stored therein; marine propulsion means operatively built into said buoyant unitary structure 13; said marine propulsion means includes said inboard electric motor 61 built into said buoyant unitary structure 13, and a propeller 62 operatively mounted to a rear portion of said buoyant unitary structure 13; said inboard electric motor 61 deriving its power from said electrical battery 60; a rudder 63 operatively mounted to a rear portion of said buoyant unitary structure 13; a joystick throttle control mechanism 64 operatively mounted on said buoyant unitary structure 13; and said joystick throttle control mechanism 64 controls said rudder 63 and controls said inboard electric motor 61 to provide variable speed, forward and reverse motion.

The second watertight floatation compartment 25 of the vehicle extends rearwardly to provide a recessed structure 68 outboard of the propeller 62 to protect the propeller 62 from damage.

The snorkel device 69 is built into an upper portion of the first buoyant unitary structure 13.

A heat-resistant barrier 71 is built around the snorkel device 69.

The apparatus 11 can thus be used with an all terrain vehicle 10 (FIGS. 1-3 and 7), or alternatively with the insertable seat device 84 (FIGS. 4-6 and 8).

Various modifications can be made in the structure and components described hereinabove.

Therefore, while there has been set forth above only some preferred embodiments of the present invention, it should be understood that the present invention is not to be limited or restricted in the particular embodiments described in detail hereinabove which have been set forth for illustrative purposes only.

The scope of the present invention is set forth in the claims which follow hereinbelow.

1. An apparatus to convert an all terrain vehicle into an amphibious off-road vehicle, comprising, in combination:
an all terrain vehicle;
a buoyant unitary structure for fitting over and onto said all terrain vehicle;
fastening means for releasably securing said buoyant unitary structure to said all terrain vehicle;
said buoyant unitary structure including two hollow floatation compartments which accommodate legs and feet of a user of said apparatus;
said buoyant unitary structure includes in a front portion thereof a first watertight floatation compartment having therein an electrical battery and space for accommodating other items to be stored therein;
said buoyant unitary structure includes in a rear portion thereof a second watertight floatation compartment having built therein an inboard electric motor and space for accommodating other items to be stored therein;
marine propulsion means operatively connected with said buoyant unitary structure;
said marine propulsion means includes said inboard electric motor built into said buoyant unitary structure, and a propeller operatively mounted to a rear portion of said buoyant unitary structure;
said inboard electric motor deriving its power from said electrical battery;
a rudder operatively mounted to a rear portion of said buoyant unitary structure;
a joystick throttle control mechanism operatively mounted on said buoyant unitary structure;
said joystick throttle control mechanism controls said rudder and controls said inboard electric motor to provide variable speed, forward and reverse motion; and
means for charging said electrical battery from an engine in said all terrain vehicle when said engine is operated.

2. An apparatus according to claim 1, wherein:
said first watertight floatation compartment extends beyond said all terrain vehicle to increase floatation of the amphibious off-road vehicle.

3. An apparatus according to claim 1, wherein:
said second watertight floatation compartment extends beyond said all terrain vehicle to increase floatation of the amphibious off-road vehicle, and extends rearwardly to provide a recessed structure outboard of said propeller to protect said propeller from damage.

4. An apparatus according to claim 2, wherein:
said second watertight floatation compartment extends beyond said all terrain vehicle to increase floatation of the amphibious off-road vehicle, and extends rearwardly to provide a recessed structure outboard of said propeller to protect said propeller from damage.

5. The apparatus of claim 1, including:
a snorkel device built into an upper portion of said buoyant unitary structure; and
said snorkel device operatively connects an exhaust pipe of said all terrain vehicle to the atmosphere.

6. The apparatus of claim 2, including:
a snorkel device built into an upper portion of said buoyant unitary structure; and
said snorkel device operatively connects an exhaust pipe of said all terrain vehicle to the atmosphere.

7. The apparatus of claim 3, including:
a snorkel device built into an upper portion of said buoyant unitary structure; and
said snorkel device operatively connects an exhaust pipe of said all terrain vehicle to the atmosphere.

8. The apparatus of claim 4, including:
a snorkel device built into an upper portion of said buoyant unitary structure; and
said snorkel device operatively connects an exhaust pipe of said all terrain vehicle to the atmosphere.

9. The apparatus of claim 5, including:
a heat-resistant barrier built around said snorkel device; and
an adaptor coupling forming part of said snorkel device for selectively and releasably clamping said snorkel device onto an end of the exhaust pipe of said all terrain vehicle.

10. The apparatus of claim 6, including:
a heat-resistant barrier built around said snorkel device; and
an adaptor coupling forming part of said snorkel device for selectively and releasably clamping said snorkel device onto an end of the exhaust pipe of said all terrain vehicle.

11. The apparatus of claim 7, including:
a heat-resistant barrier built around said snorkel device; and
an adaptor coupling forming part of said snorkel device for selectively and releasably clamping said snorkel device onto an end of the exhaust pipe of said all terrain vehicle.

12. The apparatus of claim 8, including:
a heat-resistant barrier built around said snorkel device; and
an adaptor coupling forming part of said snorkel device for selectively and releasably clamping said snorkel device onto an end of the exhaust pipe of said all terrain vehicle.

13. The apparatus claim 1, wherein:
said fastening means includes a plurality of bolts attached to said all terrain vehicle, and a plurality of wing nuts or knobs for threadedly attaching to said bolts.

14. The apparatus claim 2, wherein:
said fastening means includes a plurality of bolts attached to said all terrain vehicle, and a plurality of wing nuts or knobs for threadedly attaching to said bolts.

15. The apparatus claim 3, wherein:
said fastening means includes a plurality of bolts attached to said all terrain vehicle, and a plurality of wing nuts or knobs for threadedly attaching to said bolts.

16. The apparatus claim 12, wherein:
said fastening means includes a plurality of bolts attached to said all terrain vehicle, and a plurality of wing nuts or knobs for threadedly attaching to said bolts.

17. A marine vehicle, comprising, in combination:
a buoyant unitary structure having an opening in an upper central portion thereof;
a seat device for selectively and releasably snapping into and completely filling said opening to complete said upper portion of said buoyant unitary structure and to form a watertight structure;
said buoyant unitary structure including two hollow floatation compartments to accommodate legs and feet of a user of the marine vehicle;
said buoyant unitary structure includes in a front portion thereof a first watertight floatation compartment having therein an electrical battery and space for accommodating other items to be stored therein;
said buoyant unitary structure includes in a rear portion thereof a second watertight floatation compartment having built therein an inboard electric motor and space for accommodating other items to be stored therein;
marine propulsion means operatively built into buoyant unitary structure;
said marine propulsion means includes said inboard electric motor built into said buoyant unitary structure, and a propeller operatively mounted to a rear portion of said buoyant unitary structure;
said inboard electric motor deriving its power from said electrical battery;
a rudder operatively mounted to a rear portion of said buoyant unitary structure;
a joystick throttle control mechanism operatively mounted on said buoyant unitary structure; and
said joystick throttle control mechanism controls said rudder and controls said inboard electric motor to provide variable speed, forward and reverse motion.

18. The marine vehicle of claim 17, wherein:
said second watertight floatation compartment extends rearwardly to provide a recessed structure outboard of said propeller to protect said propeller from damage;
there is provided a snorkel device built into an upper portion of said buoyant unitary structure; and
a heat-resistant barrier built around said snorkel device.

19. A buoyant unitary apparatus, comprising:
a buoyant unitary structure having an opening in an upper central portion thereof;
said buoyant unitary structure being designed, dimensioned and configured to selectively and releasably fit over and onto an external all terrain vehicle;
said buoyant unitary structure including two hollow floatation compartments which accommodate legs and feet of a user;
said buoyant unitary structure includes in a front portion thereof a first watertight floatation compartment having therein an electrical battery and space for accommodating other items to be stored therein;
said first buoyant unitary structure includes in a rear portion thereof a second watertight floatation compartment having built therein an inboard electric motor and space for accommodating other items to be stored therein;
marine propulsion means operatively connected with said buoyant unitary structure;
said marine propulsion means includes said inboard electric motor built into said buoyant unitary structure, and a propeller operatively mounted to a rear portion of said buoyant unitary structure;
said inboard electric motor deriving its power from said electrical battery;
a rudder operatively mounted to a rear portion of said buoyant unitary structure;
a joystick throttle control mechanism operatively mounted on said buoyant unitary structure; and
said joystick throttle control mechanism controls said rudder and controls said inboard electric motor to provide variable speed, forward and reverse motion.

20. The apparatus of claim 19, including:
a snorkel device built into an upper portion of said buoyant unitary structure; and
a heat-resistant barrier built around said snorkel device.
